(19) United States
(12) Patent Application Publication
(10) Pub. No.: US 2006/0285494 A1
(43) Pub. Date: Dec. 21, 2006

(54) Dynamic link speed control

(75) Inventors: Yadong Li, Hillsboro, OR (US); Patrick L. Connor, Portland, OR (US); William B. Campbell, Beaverton, OR (US); Indumathi Madhavan, Hillsboro, OR (US); Sridharan Sakthivelu, DuPont, WA (US)

Correspondence Address: SCHWEGMAN, LUNDBERG, WOESSNER & KLUTH, P.A., P.O. BOX 2938, MINNEAPOLIS, MN, 55402, US

(73) Assignee: Intel Corporation

(21) Appl. No.: 11/155,381

(22) Filed: Jun. 17, 2005

(51) Int. Cl. H04J 1/16

(52) U.S. Cl. 370/235; 370/252

(57) ABSTRACT

Apparatus and systems, as well as methods and articles, may operate to measure a network link throughput value, compare the throughput value to a threshold value, and dynamically regulate the link speed based on the measured throughput value.

### TECHNICAL FIELD

Various embodiments described herein relate to communications technology generally, including apparatus, systems, and methods affecting network communication rates.

### BACKGROUND INFORMATION

High-speed network devices, such as those implementing the Institute of Electrical and Electronics Engineers (IEEE) 802.3ab (gigabit Ethernet) standard, may consume significant power when running at gigabit link speeds. The resulting power dissipation may increase the communication system thermal burden and shorten mobile system battery life. While mobile users, among others, may not have any need for operating at the highest network link speed all the time, higher speeds are usually desirable when downloading large data files, such as multimedia files. For more information regarding various IEEE 802.3 standards (e.g., IEEE 802.3ab), please consult “IEEE 802.3, 2000 Edition, IEEE Standard for Information Technology—Telecommunications and information exchange between systems—local and metropolitan area networks—specific requirements—Part 3: Carrier Sense Multiple Access with Collision Detection Access Method and Physical Layer Specifications,” as well as related amendments and revisions.

Attempts to reduce the link speed based on battery operation versus alternating current (AC) power tend to rely on the operating system to indicate the desired initial power profile. Such static configurations can impact the quality of service when a user initiates large file copy operations.

### BRIEF DESCRIPTION OF THE DRAWINGS

FIG. 1 is a block diagram of apparatus and systems according to various embodiments of the invention.

FIG. 2 is a flow diagram illustrating several methods according to various embodiments of the invention.

FIG. 3 is a block diagram of an article according to various embodiments of the invention.

### DETAILED DESCRIPTION

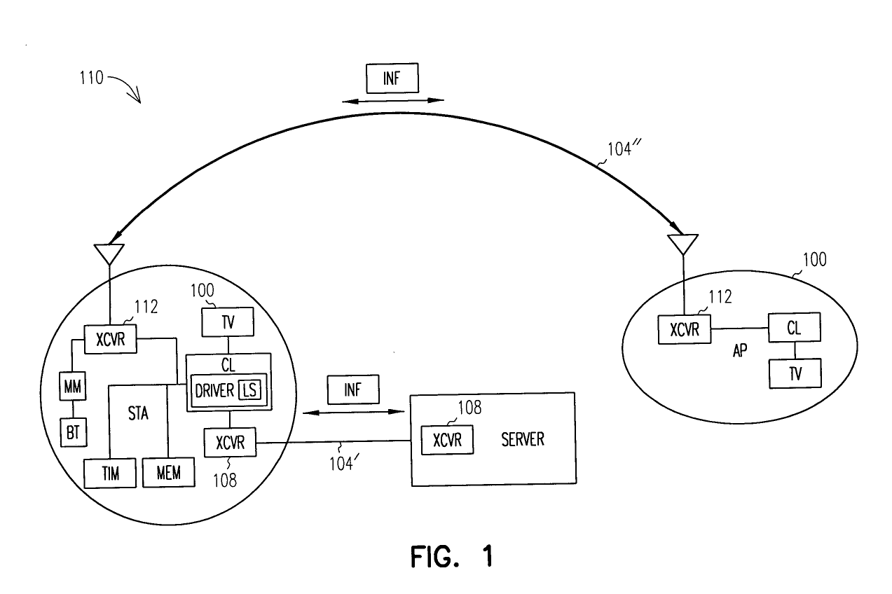

FIG. 1 is a block diagram of apparatus 100 and systems 110 according to various embodiments of the invention, which may operate to use information about network traffic throughput to dynamically configure the operational link speed. In this manner, quality of service and reduced power consumption may co-exist in conjunction with the use of a high-speed device. Assuming one embodiment of the apparatus 100 includes a gigabit Ethernet network controller with a data transceiver, a modified Ethernet network device driver, and an operating system, such as the Microsoft® Windows® XP operating system, operation might occur as follows.

The software driver (e.g., a modified Ethernet network device driver) may be loaded and executed to configure the network controller and transceiver to negotiate the highest link speed available with the link partner. The software driver can then maintain the link speed achieved with the link partner and keep statistical information about the packets sent to and received from the network controller as network throughput historical information (e.g., how many bytes/packets were transferred, transmitted, and/or received in two seconds).

If the network throughput over some recent period (e.g. the last ten seconds) is consistently lower than a defined threshold (such as 6% of the link capability), then the software driver may act to configure (e.g., renegotiate) the network device controller and transceiver to operate at a lower speed, such as stepping down from 1000 Mb/sec to 100 Mb/sec, or from 100 Mb/sec to 10 Mb/sec. If the network throughput over some recent period (e.g. the last two or four seconds) is higher than a defined threshold (such as 25% of the link capability), then the software driver may act to configure (e.g., renegotiate) the network device controller and transceiver to operate at a higher speed, such as stepping up from 10 Mb/sec to 100 Mb/sec, or from 100 Mb/sec to 1000 Mb/sec. Renegotiation may be contingent on the availability of sufficient power from the transceiver power supply, the availability of higher and lower link speeds, or both. The process of adjusting the link speed may continue in a dynamic fashion, as communication over the link proceeds and as traffic or power supply conditions change.

Thus, in some embodiments, the apparatus 100 may include control logic CL to dynamically regulate the link speed of a network 104′, 104″ responsive to a measured throughput value TV of the network 104′, 104″. Since the network 104′, 104″ may include a wired network 104′ or a wireless network 104″, the control logic CL may comprise one or more of an IEEE 802.3 network device driver, an IEEE 802.11 device driver, an IEEE 802.16 device driver, and an IEEE 802.20 device driver, among others. The driver, or a network interface card (NIC) may include a link speed control module LS. The apparatus 100 may include a wired transceiver 108 to couple to the control logic CL, and to receive information INF from a wired network 104′. For more information regarding various IEEE 802.11 standards (e.g., IEEE 802.11g), please refer to “IEEE Standards for Information Technology—Telecommunications and Information Exchange between Systems—Local and Metropolitan Area Network—Specific Requirements—Part 11: Wireless LAN Medium Access Control (MAC) and Physical Layer (PHY), ISO/IEC 8802-11: 1999” and related amendments/revisions.

Throughput can be measured in a number of ways. For example, the measured throughput value TV may be associated with a backlog (e.g., ten megabytes of data remaining to download to the apparatus 100), a queue depth (e.g., five files remaining to download to the apparatus 100), packet storage (FIFO) utilization, flow control or congestion management events, a transmission rate in bits per unit of time (e.g., Mb/sec), a transmission rate in packets per unit of time (e.g., packets/sec), a statistical measurement of a network parameter (e.g., number of bytes received over the last 10 minutes), and a remaining battery capacity (e.g., 70% of capacity, or xx minutes remaining).

Other embodiments may be realized. For example, a system 110 may include one or more of the apparatus 100, as described previously. In addition, the system 110 may include one or more wireless transceivers (XCVRs) 112 (e.g., a cellular telephone transceiver) to couple to the control logic CL, and to receive information INF from a wireless network 104″.

The apparatus 100 may also include a battery power measurement module MM to measure the remaining amount of capacity associated with a battery BT coupled to the control logic CL (either directly, or indirectly, as shown in FIG. 1). In some embodiments, the apparatus 100 may include a memory MEM to store information associated with the measured throughput value TV, and a timer TIM to couple to the control logic CL. The timer TM may be used to assist in determining the throughput value TV when measuring the amount of information INF received over some period of time.

Any of the components previously described can be implemented in a number of ways, including simulation via software. Thus, the apparatus 100; networks 104′, 104″; wired transceiver 108; system 110; wireless transceiver 112; battery BT; control logic CL; information INF; link speed control module LS; memory MEM; measurement module MM; timer TIM; and throughput value TV may all be characterized as “modules” herein. The modules may include hardware circuitry, single or multi-processor circuits, memory circuits, software program modules and objects, firmware, and combinations thereof, as desired by the architect of the apparatus 100 and systems 110, and as appropriate for particular implementations of various embodiments. The modules may be included in a system operation simulation package such as a software electrical signal simulation package, a power usage and distribution simulation package, a network loading simulation package, a power/heat dissipation simulation package, a signal transmission-reception simulation package, or any combination of software and hardware used to simulate the operation of various potential embodiments. Such simulations may be used to characterize or test the embodiments, for example.

It should also be understood that the apparatus and systems of various embodiments can be used in applications other than measuring throughput values for network links. Thus, various embodiments of the invention are not to be so limited. The illustrations of apparatus 100 and systems 110 are intended to provide a general understanding of the structure of various embodiments, and they are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single or multi-processor modules, single or multiple embedded processors, data switches, and application-specific modules, including multilayer, multi-chip modules. Such apparatus and systems may further be included as sub-components within a variety of electronic systems, such as televisions, cellular telephones, personal computers, workstations, radios, video players, vehicles, and others.

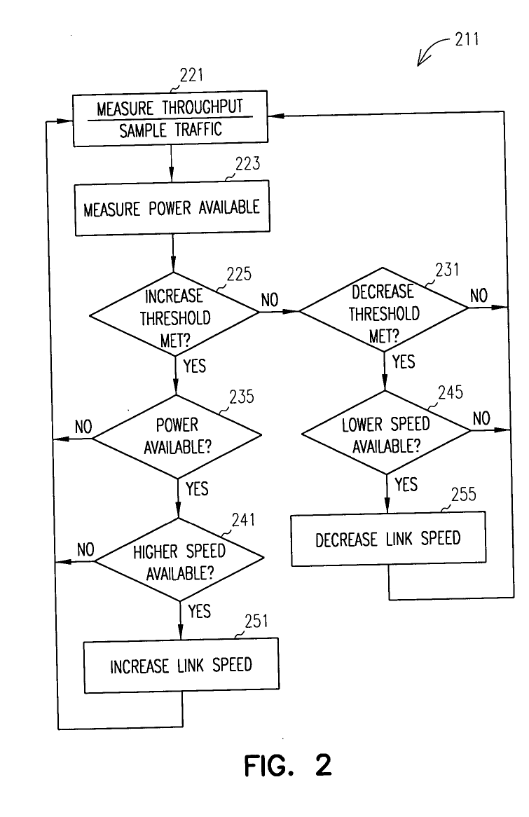

Some embodiments may include a number of methods. For example, FIG. 2 is a flow diagram illustrating several methods 211 according to various embodiments of the invention. One such method 211 may begin at block 221 with measuring a network link throughput value, as described previously. Measuring the network throughput value may include sampling the network traffic within a wired network, a wireless network, or within a combination of both types of networks. For example, measuring the network link throughput value may occur across a plurality of related packet transmissions in one or more networks and/or network types. Measurements of the available power in a battery-powered device, via the battery power setting (e.g., battery or AC power), remaining battery capacity (e.g., operational time remaining if the current battery remains as the sole source of power), and/or percentage power setting (e.g., percentage of battery capacity remaining) may also occur at block 223.

The method 211 may continue with comparing the network link throughput value to a threshold value at blocks 225 and 231. The threshold value may be derived from a throughput capability of the network link (e.g., if the network is capable of 10 Mb/sec communications, the threshold may be set to 10% (1 Mb/sec) or 25% (2.5 Mb/sec) of this value). Thus, the comparison at block 225 may be to determine if the network link throughput value is greater than a threshold value comprising an upper threshold value (e.g., 25% of the network throughput capability). The comparison at block 231 may be to determine if the network link throughput value is less than a threshold value comprising a lower threshold value (e.g., 6% or 10% of the network throughput capability).

Another possible comparison that may be implemented at block 231 includes determining if the remaining battery capacity is less than a threshold capacity. If such is the case, a lower link speed may be desirable. Similarly, in some embodiments, the method 211 may operate to determine whether sufficient power is available to implement a higher network link speed at block 235.

At blocks 241 and 245, the method 211 may operate to determine whether a higher or lower link speed than that currently in use is available, respectively. Thus, if it is determined that a higher link speed is available at block 241, then the method 211 may include increasing the link speed at block 251, perhaps by renegotiating the link speed in use to the higher link speed. Similarly, if it is determined that a lower link speed is available at block 245, then the method 211 may include decreasing the link speed at block 255, perhaps by renegotiating the link speed in use to the lower link speed.

Therefore, it can be seen that in many embodiments, the method 211 includes dynamically regulating the link speed of a network link based on a measured network link throughput value, perhaps by renegotiating the link speed. This includes renegotiating the link speed to a lower speed if the network link throughput value is less than a threshold value comprising a lower threshold value. This also includes renegotiating the link speed to a higher speed if the network link throughput value is greater than a threshold value comprising an upper threshold value.

Many other embodiments may be realized. For example, the method 211 may include dynamically renegotiating the link speed at blocks 251 and 255 based upon the battery power setting, the remaining battery capacity, and/or the percentage power setting. Other embodiments include determining that the link speed should be negotiated to a higher link speed at block 251, perhaps responsive to the availability of the higher link speed and sufficient battery power to support the higher link speed for a selected amount of time. Further embodiments of the method 211 may include renegotiating the link speed to a lower speed at block 255 if the network link throughput value is less than a threshold value comprising a lower threshold value, as well as renegotiating the link speed to a higher speed at block 251 if the network link throughput value is greater than a threshold value comprising an upper threshold value.

Some embodiments of the method 211 may include measuring the remaining battery capacity at block 223, and renegotiating the link speed to a lower speed at block 255 if the remaining battery capacity is less than a threshold capacity, or if the network link throughput value is less than a threshold value comprising a lower threshold value at block 231. Other embodiments may include measuring the remaining battery capacity at block 223, and then renegotiating the link speed to a higher speed at block 251 if the remaining battery capacity is greater than a threshold capacity at block 235 and if the network link throughput value is greater than the threshold value comprising an upper threshold value at block 225.

The methods described herein do not have to be executed in the order described, or in any particular order. Moreover, various activities described with respect to the methods identified herein can be executed in repetitive, serial, or parallel fashion. Information, including parameters, commands, operands, and other data, can be sent and received in the form of one or more carrier waves.

One of ordinary skill in the art will understand the manner in which software can be launched from a computer-readable medium in a computer-based system to execute the functions defined in the software. Various programming languages may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembly or C. The software components may communicate using a number of mechanisms well known to those skilled in the art, such as application program interfaces or interprocess communication techniques, including remote procedure calls. The teachings of various embodiments are not limited to any particular programming language or environment.

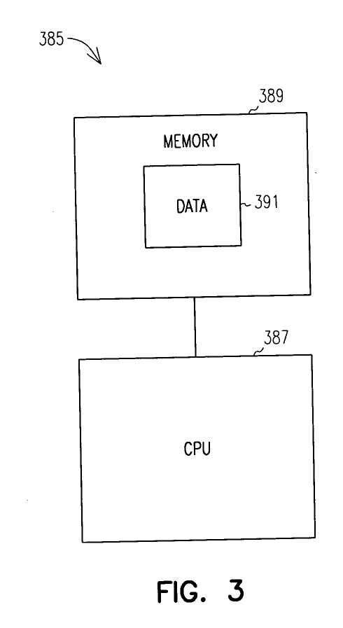

Thus, other embodiments may be realized. For example, FIG. 3 is a block diagram of an article 385 according to various embodiments of the invention. Examples of such embodiments may comprise a computer, a memory system, a magnetic or optical disk, some other storage device, or any type of electronic device or system. The article 385 may include one or more processor(s) 387 coupled to a machine-accessible medium such as a memory 389 (e.g., a memory including an electrical, optical, or electromagnetic conductor). The medium may contain associated information 391 (e.g., computer program instructions, data, or both) which, when accessed, results in a machine (e.g., the processor(s) 387) measuring a network link throughput value, comparing the network link throughput value to a threshold value, and dynamically regulating a link speed of the network link based on the network link throughput value.

Further activities may include renegotiating the link speed to a lower speed if the network link throughput value is less than a threshold value comprising a lower threshold value, and renegotiating the link speed to a higher speed if the network link throughput value is greater than a threshold value comprising an upper threshold value. Other activities may include measuring a remaining battery capacity and renegotiating the link speed to a lower speed if the remaining battery capacity is less than a threshold capacity or if the network link throughput value is less than a threshold value comprising a lower threshold value. Similarly, such activities may include measuring a remaining battery capacity and renegotiating the link speed to a higher speed if the remaining battery capacity is greater than a threshold capacity and if the network link throughput value is greater than a threshold value comprising an upper threshold value.

Implementing the apparatus, systems, and methods disclosed herein may permit software drivers to configure link speeds to dynamically match network traffic conditions, while reducing power consumption in many situations. This is because a gigabit link may consume more than 1.5 W, while a 100 Mb/sec link may only consume about 500 mW, and a 10 Mb/sec link may only consume about 250 mW. Therefore, running at lower speeds may reduce power consumption by a factor of five or more, extending mobile system battery life.

Further, the operation of the apparatus, systems, and methods described can be dynamic, overcoming problems that may be encountered when only the lowest available link speed is selected. Thus, when a user is copying/downloading a large file, a link speed may be selected that takes advantage of the full network capability, enhancing the user experience.

Although the inventive concept may be described in the exemplary context of an 802.xx implementation (e.g., 802.3ab, 802.11a, 802.11g, 802.11 HT, 802.11k, 802.16, 802.20, etc.), the claims are not so limited. Embodiments of the present invention may well be implemented as part of any wired or wireless system. Examples may also include embodiments comprising multi-carrier wireless communication channels (e.g., orthogonal frequency-division multiplexing (OFDM), discrete multi-tone modulation (DMT), etc.) such as may be used within a wireless personal area network (WPAN), a wireless local area network (WLAN), a wireless metropolitan area network (WMAN), a wireless wide area network (WWAN), a cellular network, a third generation (3G) network, a fourth generation (4G) network, a universal mobile telephone system (UMTS), and like communication systems, without limitation.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R., §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. An apparatus, including:
control logic to dynamically regulate a link speed of a network responsive to a measured throughput value of the network.

2. The apparatus of claim 1, wherein the control logic comprises one of an Institute of Electrical and Electronic Engineers (IEEE) 802.3 network device driver, an IEEE 802.11 device driver, an IEEE 802.16 device driver, and an IEEE 802.20 device driver.

3. The apparatus of claim 1, wherein the measured throughput value is associated with one of a backlog, a queue depth, a transmission rate in bits per unit of time, a transmission rate in packets per unit of time, a statistical measurement of a network parameter, a packet storage utilization, a flow control event, a congestion management event, and a remaining battery capacity.

4. The apparatus of claim 1, wherein the network comprises a wired network, further including:
a wired transceiver to receive information from the wired network and to couple to the control logic.

5. The apparatus of claim 1, further including:
a battery power measurement module to measure a remaining amount of capacity associated with a battery coupled to the control logic.

6. A system, including:
control logic to dynamically regulate a link speed of a network responsive to a measured throughput value of the network; and
a wireless transceiver coupled to the control logic.

7. The system of claim 6, wherein the measured throughput value is associated with one of a backlog, a queue depth, a transmission rate in bits per unit of time, a transmission rate in packets per unit of time, a statistical measurement of a network parameter; a packet storage utilization, a flow control event, a congestion management event, and a remaining battery capacity.

8. The system of claim 6, wherein the network comprises a wireless network and wherein the wireless transceiver is to couple to the network.

9. The system of claim 6, wherein the wireless transceiver includes a cellular telephone transceiver.

10. The system of claim 6, further including:
a memory to store information associated with the measured throughput value; and
a timer to couple to the control logic.

11. A method, including:
measuring a network link throughput value;
comparing the network link throughput value to a threshold value; and
dynamically regulating a link speed of the network link based on the network link throughput value.

12. The method of claim 11, further including:
renegotiating the link speed to a lower speed if the network link throughput value is less than the threshold value comprising a lower threshold value.

13. The method of claim 11, further including:
renegotiating the link speed to a higher speed if the network link throughput value is greater than the threshold value comprising an upper threshold value.

14. The method of claim 11, wherein the threshold value is derived from a throughput capability of the network link.

15. The method of claim 11, wherein the network comprises a wireless network.

16. The method of claim 11, further including:
measuring the network link throughput value across a plurality of related packet transmissions.

17. The method of claim 11, further including:
dynamically renegotiating the link speed based upon one of a battery power setting, a remaining battery capacity, and a percentage power setting.

18. The method of claim 11, further including:
determining that a lower link speed is available; and
renegotiating the link speed to the lower link speed.

19. The method of claim 11, further including:
determining that a higher link speed is available; and
renegotiating the link speed to the higher link speed.

20. The method of claim 11, further including:
determining that the link speed should be negotiated to a higher link speed responsive to the availability of the higher link speed and sufficient battery power to support the higher link speed for a selected amount of time.

21. An article including a machine-accessible medium having associated information, wherein the information, when accessed, results in a machine performing:
measuring a network link throughput value;
comparing the network link throughput value to a threshold value; and
dynamically regulating a link speed of the network link based on the network link throughput value.

22. The article of claim 21, wherein the information, when accessed, results in a machine performing:
renegotiating the link speed to a lower speed if the network link throughput value is less than the threshold value comprising a lower threshold value; and
renegotiating the link speed to a higher speed if the network link throughput value is greater than the threshold value comprising an upper threshold value.

23. The article of claim 21, wherein the information, when accessed, results in a machine performing:
measuring a remaining battery capacity; and
renegotiating the link speed to a lower speed if the remaining battery capacity is less than a threshold capacity or the network link throughput value is less than the threshold value comprising a lower threshold value.

24. The article of claim 21, wherein the information, when accessed, results in a machine performing:
measuring a remaining battery capacity; and
renegotiating the link speed to a higher speed if the remaining battery capacity is greater than a threshold capacity and if the network link throughput value is greater than the threshold value comprising an upper threshold value.
